(19) United States
(12) Patent Application Publication
(10) Pub. No.: US 2003/0093256 A1
(43) Pub. Date: May 15, 2003

(54) Verification simulator agnosticity

(76) Inventors: Carl Cavanagh, Oakland, CA (US); Carl B. Frankel, San Francisco, CA (US); James P. Freyensee, Los Altos, CA (US); Steven A. Sivier, Fremont, CA (US)

Correspondence Address: Lawrence J. Merkel, Conley, Rose, & Tayon, P.C., P.O. Box 398, Austin, TX, 78767, US

(21) Appl. No.: 10/008,270

(22) Filed: Nov. 9, 2001

(51) Int. Cl. G06F 17/50

(52) U.S. Cl. 703/14

(57) ABSTRACT

A distributed simulation system is described which is agnostic to the simulator program used in each node. That is, different nodes may include simulator programs which differ from each other (e.g. the instruction code comprising one of the simulator programs differs from the instruction code comprising another one of the simulator programs). For example, the different simulator programs may employ different event schedulers, if the different simulator programs are event-based, in one embodiment. As another example, the different simulator programs may be a mix of event-based and cycle-based simulators.

### BACKGROUND OF THE INVENTION

1. Field of the Invention

This invention is related to the field of distributed simulation systems.

2. Description of the Related Art

Generally, the development of components for an electronic system such as a computer system includes simulation of models of the components. In the simulation, the specified functions of each component may be tested and, when incorrect operation (a bug) is detected, the model of the component may be changed to generate correct operation. Once simulation testing is complete, the model may be fabricated to produce the corresponding component. Since many of the bugs may have been detected in simulation, the component may be more likely to operate as specified and the number of revisions to hardware may be reduced. The models are frequently described in a hardware description language (HDL) such as Verilog, VHDL, etc. The HDL model may be simulated in a simulator designed for the HDL, and may also be synthesized, in some cases, to produce a netlist and ultimately a mask set for fabricating an integrated circuit.

Originally, simulations of electronic systems were performed on a single computing system. However, as the electronic systems (and the components forming systems) have grown larger and more complex, single-system simulation has become less desirable. The speed of the simulation (in cycles of the electronic system per second) may be reduced due to the larger number of gates in the model which require evaluation. Additionally, the speed may be reduced as the size of the electronic system model and the computer code to perform the simulation may exceed the memory capacity of the single system. As the speed of the simulation decreases, simulation throughput is reduced.

To address some of these issues, distributed simulation has become more common. Generally, a distributed simulation system includes two or more computer systems simulating portions of the electronic system in parallel. Each computer system must communicate with other computer systems simulating portions of the electronic system to which the portion being simulated on that computer system communicates, to pass signal values of the signals which communicate between the portions. Generally, distributed simulation systems sample output signals from the model in each node and communicate the corresponding signal values to other nodes. The received signal values are then driven as inputs to the models in those other nodes.

### SUMMARY OF THE INVENTION

A distributed simulation system is described which includes a first node and a second node. The first node is configured to simulate a first portion of a system under test using a first simulator program. The second node is configured to simulate a second portion of a system under test using a second simulator program. The instruction code comprising the first simulator program differs from the instruction code comprising the second simulator program. The first node and the second node communicate at least signal values during the simulation using a grammar.

### BRIEF DESCRIPTION OF THE DRAWINGS

The following detailed description makes reference to the accompanying drawings, which are now briefly described.

FIG. 1 is a block diagram of one embodiment of a distributed simulation system.

FIG. 2 is a block diagram of one embodiment of a set of nodes shown in FIG. 1, illustrating different simulator programs therein.

FIG. 3 is a block diagram of one embodiment of a distributed simulation node.

FIG. 4 is a block diagram of one embodiment of a distributed control node.

FIG. 5 is a block diagram of one embodiment of a hub.

FIG. 6 is a timing diagram illustrating operation of one embodiment of a DSN during a simulation timestep.

FIG. 7 is a timing diagram illustrating operation of another embodiment of a DSN during a simulation timestep.

FIG. 8 is a flowchart illustrating operation of one embodiment of a PLIDone model shown in FIG. 3 during simulation startup.

FIG. 9 is a state machine illustrating one embodiment of a non-blocking assignment logic circuit which may be included in one embodiment of the PLIDone model shown in FIG. 3.

FIG. 10 is a flowchart illustrating operation of one embodiment of additional logic configured to schedule a PLI callback responsive to the non-blocking assignment.

FIG. 11 is a flowchart illustrating operation of one embodiment of the DSN during the sample portion of a real time phase.

FIG. 12 is a flowchart illustrating operation of one embodiment of the DSN during the drive portion of a real time phase.

FIG. 13 is a flowchart illustrating operation of one embodiment of a DSN having a cycle based simulator.

FIG. 14 is a block diagram illustrating logical ports in an exemplary distributed simulation.

FIG. 15 is a block diagram of one embodiment of a message packet.

FIG. 16 is a table illustrating exemplary commands.

FIG. 17 is a definition, in Backus-Naur Form (BNF), of one embodiment of a POV command.

FIG. 18 is a definition, in BNF, of one embodiment of an SCF command.

FIG. 19 is a definition, in BNF, of one embodiment of a DDF command.

FIG. 20 is an example distributed simulation system.

FIG. 21 is an example POV command for the system shown in FIG. 20.

FIG. 22 is an example SCF command for the system shown in FIG. 20.

FIG. 23 is an example DDF command for the chip1 element shown in FIG. 20.

FIG. 24 is an example DDF command for the chip2 element shown in FIG. 20.

FIG. 25 is an example DDF command for the rst_ctl element shown in FIG. 20.

FIG. 26 is a block diagram of one embodiment of a carrier medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Distributed Simulation System Overview

In the discussion below, both the computer systems comprising the distributed simulation system (that is, the computer systems on which the simulation is being executed) and the electronic system being simulated are referred to. Generally, the electronic system being simulated will be referred to as the “system under test”.

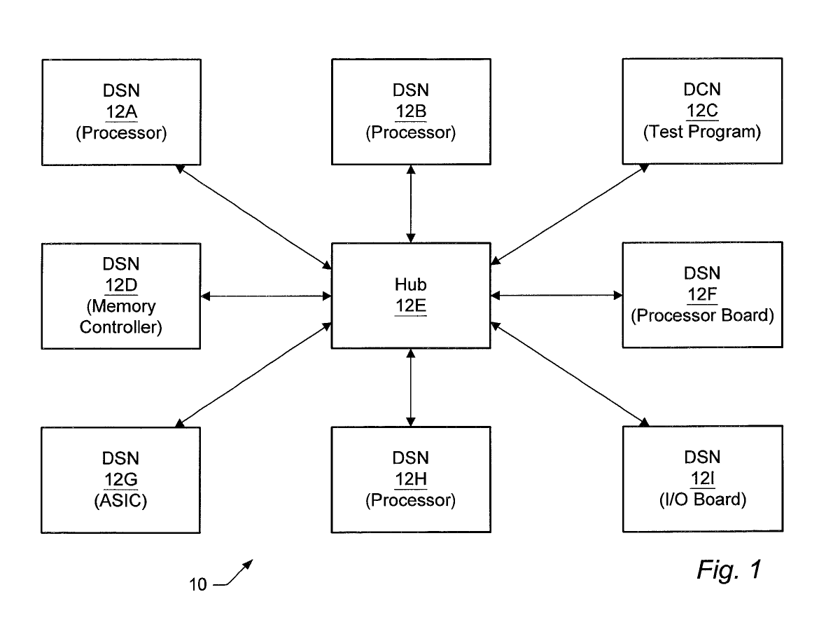

Turning now to FIG. 1, a block diagram of one embodiment of a distributed simulation system 10 is shown. Other embodiments are possible and contemplated. In the embodiment of FIG. 1, the system 10 includes a plurality of nodes 12A-12I. Each node 12A-12D and 12F-12I is coupled to communicate with at least node 12E (which is the hub of the distributed simulation system). Nodes 12A-12B, 12D, and 12F-12I are distributed simulation nodes (DSNs), while node 12C is a distributed control node (DCN).

Generally, a node is the hardware and software resources for: (i) simulating a component of the system under test; or (ii) running a test program or other code (e.g. the hub) for controlling or monitoring the simulation. A node may include one or more of: a computer system (e.g. a server or a desktop computer system), one or more processors within a computer system (and some amount of system memory allocated to the one or more processors) where other processors within the computer system may be used as another node or for some other purpose, etc. The interconnection between the nodes illustrated in FIG. 1 may therefore be a logical interconnection. For example, in one implementation, Unix sockets are created between the nodes for communication. Other embodiments may use other logical interconnection (e.g. remote procedure calls, defined application programming interfaces (APIs), shared memory, pipes, etc.). The physical interconnection between the nodes may vary. For example, the computer systems including the nodes may be networked using any network topology. Nodes operating on the same computer system may physically be interconnected according to the design of that computer system.

A DSN is a node which is simulating a component of the system under test. A component may be any portion of the system under test. For example, the embodiment illustrated in FIG. 1 may be simulating a computer system, and thus the DSNs may be simulating processors (e.g. nodes 12A-12B and 12H), a processor board on which one or more of the processors may physically be mounted in the system under test (e.g. node 12F), an input/output (I/O) board comprising input/output devices (e.g. node 12I), an application specific integrated circuit (ASIC) which may be mounted on a processor board, a main board of the system under test, the I/O board, etc. (e.g. node 12G), or a memory controller which may also be mounted on a processor board, a main board of the system under test, the I/O board, etc. (e.g. node 12D).

Depending on the configuration of the system under test, various DSNs may communicate. For example, if the processor being simulated on DSN 12A is mounted on the processor board being simulated on DSN 12F in the system under test, then input/output signals of the processor may be connected to output/input signals of the board. If the processor drives a signal on the board, then a communication between DSN 12A and DSN 12F may be used to provide the signal value being driven (and optionally a strength of the signal, in some embodiments). Additionally, if the processor being simulated on DSN 12A communicates with the memory controller being simulated on DSN 12D, then DSNs 12A and 12D may communicate signal values/strengths.

A DCN is a node which is executing a test program or other code which is not part of the system under test, but instead is used to control the simulation, introduce some test value or values into the system under test (e.g. injecting an error on a signal), monitor the simulation for certain expected results or to log the simulation results, etc.

A DCN may communicate with a DSN to provide a test value, to request a value of a signal or other hardware modeled in the component simulated in the DSN, to communicate commands to the simulator in the DSN to control the simulation, etc.

The hub (e.g. node 12E in FIG. 1) is provided for routing communications between the various other nodes in the distributed simulation system. Each DSN or DCN transmits commands to the hub, which parses the commands and forwards commands to the destination node or nodes for the command. Additionally, the hub may be the destination for some commands (e.g. for synchronizing the simulation across the multiple DSNs and DCNs).

The format and interpretation of the commands may be specified by a grammar implemented by the nodes 12A-12I. The grammar is a language comprising predefined commands for communicating between nodes, providing for command/control messages for the simulation as well as commands transmitting signal values (and optionally signal strength information). Commands transmitting signal values are referred to as transmit commands herein. In addition to the transmit commands, the grammar may include a variety of other commands. For example, commands to control the start, stop, and progress of the simulation may be included in the grammar. Furthermore, a user command may be included which allows for an arbitrary string (e.g. code to be executed, or a message to code executing in a node) to be passed between nodes.

Generally, the commands may be transmitted between the nodes in any suitable fashion. For example, message packets may be passed between the nodes. Each node may format the commands to be transmitted into message packets, and may parse received message packets to detect the command or commands included therein, and the arguments of those commands. Message packets containing transmit commands may be referred to as signal transmission message packets herein.

While the embodiment shown in FIG. 1 includes a node operating as a hub (node 12E), other embodiments may not employ a hub. For example, DSNs and DCNs may each be coupled to the others to directly send commands to each other. Alternatively, a daisy chain or ring connection between nodes may be used (where a command from one node to another may pass through the nodes coupled therebetween). In some embodiments including a hub, the hub may comprise multiple nodes. Each hub node may be coupled to one or more DSN/DCNs and one or more other hub nodes (e.g. in a star configuration among the hub nodes). In some embodiments, a DCN or DSN may comprise multiple nodes.

In one embodiment, the grammar may include one or more commands for defining the configuration of the system under test. In one embodiment, these commands include a port of view (POV) command, a device description file (DDF) command, and a system configuration file (SCF) command. These commands may, in one implementation, be stored as files rather than message packets transmitted between nodes in the distributed simulation system. However, these commands are part of the grammar and may be transmitted as message packets if desired.

The POV command defines the logical port types for the system under test. Generally, signal information (which includes at least a signal value, and may optionally include a strength for the signal) is transmitted through a logical port in a message packet. That is, a message packet which is transmitting signal information transmits the signal information for one or more logical ports of a port type defined in the POV command. Accordingly, the POV command specifies the format of the signal transmission message packets. Generally, a logical port is an abstract representation of one or more physical signals. For example, the set of signals which comprises a particular interface (e.g. a predefined bus interface, a test interface, etc.) may be grouped together into a logical port. Transmitting a set of values grouped as a logical port may more easily indicate to a user that a communication is occurring on the particular interface than if the physical signals are transmitted with values.

In one embodiment, the logical ports may be hierarchical in nature. In other words, a given logical port may contain other logical ports. Accordingly, multiple levels of abstraction may be defined, as desired. For example, a bus interface which is pipelined, such that signals are used at different phases in a transaction on the bus interface (e.g. arbitration phase, address phase, response phase, etc.) may be grouped into logical ports for each phase, and the logical ports for the phases may be grouped into a higher level logical port for the bus as a whole. Specifically, in one embodiment, a logical port comprises at least one logical port or logical signal, and may comprise zero or more logical ports and zero or more logical signals in general. Both the logical ports and the logical signals are defined in the POV command. It is noted that the term “port” may be used below instead of “logical port”. The term “port” is intended to mean logical port in such contexts.

The DDF command is used to map logical signals (defined in the POV command) to the physical signals which appear in the models of the components of the system under test. In one embodiment, there may be at least one DDF command for each component in the system under test.

The SCF command is used to instantiate the components of the system under test and to connect logical ports of the components of the system under test. The SCF command may be used by the hub for routing signal transmission message packets from one node to another.

As used herein, a physical signal is a signal defined in the simulation model of a given component of the system under test (e.g. an HDL model or some other type of model used to represent the given component). A logical signal is a signal defined using the grammar. Logical signals are mapped to physical signals using one or more grammar commands.

It is noted that, while one described embodiment may include mappings of physical signals to logical signals and ports and the routing of transmit commands using the logical signals and ports, other embodiments may use transmit commands which carry the physical signals and corresponding values. In such embodiments, the POV and DDF commands may be eliminated.

Simulator Agnosticity

The distributed simulation system 10 may be designed to be insensitive to the simulator program included in each node. That is, different simulator programs may be included in some of the DSNs in a given distributed simulation. Generally, the instruction code comprising one simulator program may differ from the instruction code of a different simulator program. For example, the different simulator programs may be products produced by different companies.

Since simulator programs from different companies may be used in a given distributed simulation, the number of licenses (also sometimes referred to as the number of seats) for a given simulator program may not limit the number of DSN nodes in the distributed simulation. If the same simulator program product were used on each node, the number of DSN nodes may be limited to the number of licenses for that simulator program (or alternatively, more licenses may be purchased to allow the simulation to proceed). On the other hand, using different simulator programs on different nodes, a distributed simulation having more DSN nodes than the number of licenses may be performed.

In some cases, a given component model may be more efficiently simulated by a particular simulator program, while other nodes may use a different simulator program. Since the distributed simulation system 10 supports different simulators in different nodes the distributed simulation system may be optimized by selecting the most efficient simulator program for one or more components in the system under test even if the selected simulator program differs from the simulator programs used in other nodes.

Additionally, in embodiments in which each simulator program is an event-based simulator generally conforming to a specification (e.g. for Verilog models, the IEEE 1364-1995 specification), there may be flexibility in the specification which may lead to different simulation results by the different simulator programs when running a simulation on a given component. For example, the event schedulers within different simulator programs compliant with the IEEE 1364-1995 specification may evaluate the events within the timestep in a different order. If the component being simulated has a race condition in it, evaluating the events corresponding to the race condition in a different order may lead to differences in the simulation result (e.g. differences in the way the race condition is resolved). Thus, running a distributed simulation multiple times, substituting the simulator program used in a given node or nodes among the different simulator programs, may enhance the verification of the component(s) in the given node(s), and even enhance the verification of the system under test as a whole.

While the above example described different event-based simulator programs being used in different DSN nodes, other embodiments also contemplate the mixture of one or more cycle-based simulator programs in some DSN nodes with event-based simulator programs in other nodes.

As used herein, a simulator program is a program designed to interface to a model and to simulate the model given one or more test stimulus inputs. A simulator program may also be referred to herein as simply a simulator. A program comprises instructions executable to perform the functions assigned to that program. The term code sequence may also be used, and a code sequence comprises instructions executable to perform the functions assigned to that code sequence. Simulator programs may be either event-based or cycle-based. Cycle-based simulators wait for a clock edge and then evaluate all logic in the model which receives inputs timed from that clock edge until a subsequent clock edge is encountered (e.g. the logic ends in a storage device clocked by the clock). Event-based simulators simulate the model as a set of discrete events. Generally, events may include update events and evaluation events. An update event is a change in a signal value or register value. An evaluation event is the evaluation of a process (e.g. a circuit or other Verilog construct having the signal value as an input) which is sensitive to the update event. Events are scheduled either for the current simulation time (a simulation time within the current timestep) or a future simulation time (a time beyond the current simulation time by more than a timestep). The simulation time from a causal event to the resulting event is the approximate amount of actual time that the corresponding circuitry would require to respond to the causal event to generate the resulting event.

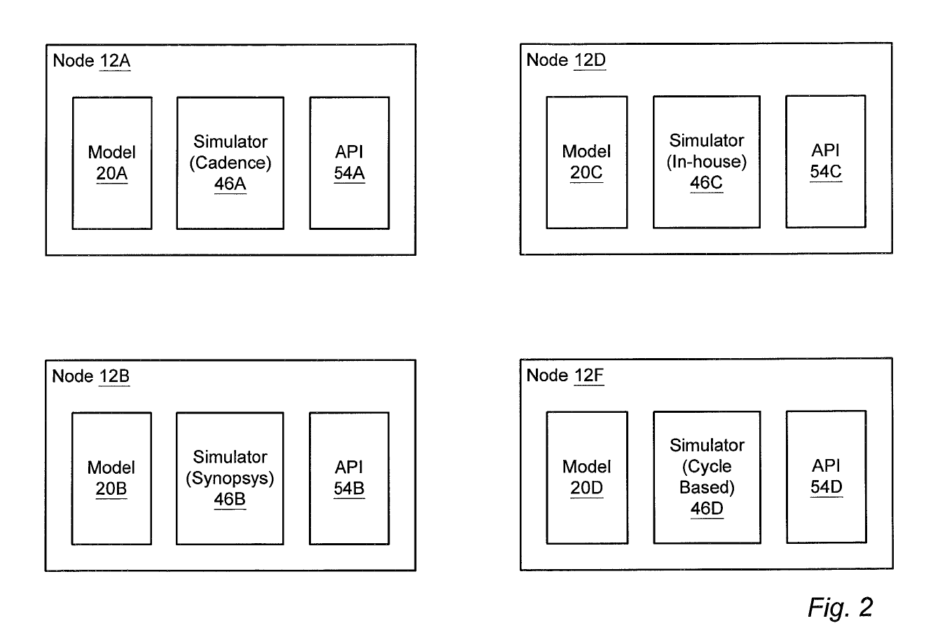

FIG. 2 is a block diagram illustrating one embodiment of several of the DSN nodes shown in FIG. 1 (particularly, nodes 12A, 12B, 12D, and 12F). FIG. 2 may be an example of using different simulator programs in different nodes. FIG. 2 is merely exemplary, however. Any node may use any simulator program, in other embodiments. Each of the nodes in FIG. 2 includes a model (e.g. models 20A, 20B, 20C, and 20D in nodes 12A, 12B, 12D, and 12F, respectively), a simulator program (e.g. simulator programs 46A, 46B, 46C, and 46D in nodes 12A, 12B, 12D, and 12F, respectively), and an application programming interface (API) (e.g. APIs 54A, 54B, 54C, and 54D in nodes 12A, 12B, 12D, and 12F, respectively).

In the example of FIG. 2, the simulator program 46A is the NCVerilog program manufactured by Cadence Design Systems, Inc. (San Jose, Calif.); the simulator program 46B is the VCS program manufactured by Synopsys, Inc. (Mountain View, Calif.); the simulator program 46C is an in-house generated simulator (i.e. a simulator program written by the company performing the distributed simulation) compliant with the IEEE 1394-1995 specification, and the simulator program 46D is a cycle-based simulator. Thus, each of the models 20A-20C may be based on Verilog descriptions. In some embodiments, the Verilog description may be compiled from its text form to a form more conducive to interfacing with the corresponding simulator program 46A-46C. Generally, a model is a representation of circuitry to perform one or more functions (e.g. a behavioral level representation, a register-transfer level (RTL) representation, etc.). The model 20D may be a model compiled for a cycle-based simulator. The model 20D may be based on any HDL description, as desired. Other simulators may be used, as desired, (e.g. the VerilogXL simulator from Cadence, SystemSim from Co-Design Automation, Inc. of Los Altos, Calif., SpeedSim from Cadence, etc.).

The APIs 54A-54D may be provided for communicating with other nodes according to the grammar employed by the distributed simulation system 10. Generally, each API 54A-54D may comprise instructions executable to communicate using the grammar (e.g. to parse received message packets and to format message packets for sending). The APIs may further include instructions executable to interface with the corresponding simulator 46A-46D. Thus, each of the APIs 54A-54D may differ in implementation depending on the simulator to which that API interfaces. In one embodiment, the APIs 54A-54C may be similar since the corresponding simulators are compliant with the IEEE 1364-1995 specification. It is noted that, while the APIs 54A-54D are shown separate from the corresponding simulators 46A-46D, the function of the APIs 54A-54D may be integrated into the simulators 46A-46D in other embodiments.

It is noted that other DSN nodes (e.g. nodes 12G-12I in FIG. 1) may employ simulator programs similar to those shown in any of nodes 12A, 12B, 12D or 12F, or any other simulator program, as desired.

Additional Details, One Embodiment

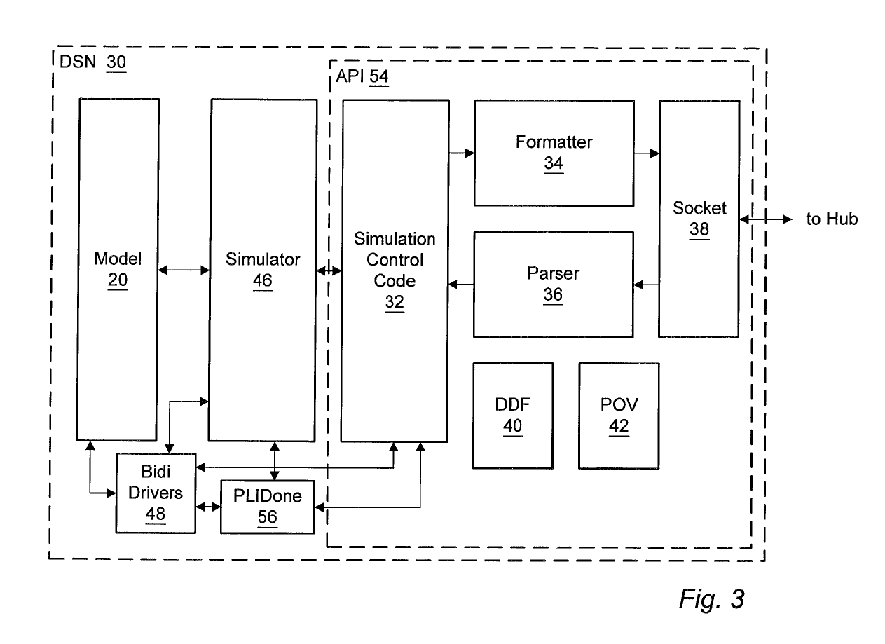

FIGS. 3-5 illustrate additional details of one embodiment of a DSN, a DCN, and a hub. Other embodiments are possible and contemplated. The embodiment of FIGS. 3-5 is provided merely as an example of various programs that may be included in a DSN, a DCN, and a hub.

Turning now to FIG. 3, a block diagram of one embodiment of a DSN 30 is shown. The DSN 30 may be an example of the instruction code included in any of the nodes 12A-12B, 12D, or 12F-12I shown in FIG. 1. Other embodiments are possible and contemplated. In the embodiment of FIG. 3, the DSN 30 includes a model 20, a set of bi-directional drivers (bidi drivers) 48, a PLIDone model 56, a simulator 46, simulation control code 32, a formatter 34, a parser 36, and a socket 38. The DSN 30 may further include a DDF file 40 and a POV file 42. Each of the simulator 46, the simulation control code 32, the formatter 34, the parser 36, and the socket 38 comprise instruction sequences for performing various functions. While illustrated separately in FIG. 3, these instruction sequences may be combined, as desired. The illustration in FIG. 3 is a logical partitioning of the function which may not be maintained in the actual program code files, if desired.

Generally, the model 20 may be a simulatable model of a component of a system under test. For example, the model 20 may be similar to any of the models 20A-20D shown in FIG. 2. The model may be an HDL model (e.g. a Verilog model, a VHDL model, etc.). The model may be a register transfer level (RTL) model of the design of the component. Alternatively, the model may be a behavioral description of the operation of the component, again written in HDL. The model may be a behavioral or functional model written in a verification language such as Vera®. Vera® may be a hardware verification language. A hardware verification language may provide a higher level of abstraction than an HDL. The model may also be coded in other languages (e.g. high level programming languages such as C or C++). It is further contemplated that a “model” could also be the hardware component, instantiated with interface logic allowing signals to be sampled and driven in response to the simulation.

The bidi drivers 48 may be used if the model 20 includes one or more bi-directional signals. One RTL driver circuit may be included for each bi-directional signal. The simulation control code 32 may place a value to be driven on a bi-directional signal (based on transmit commands received from other nodes having models coupled to the same bi-directional signal) and enable the driver to supply the proper state on the bi-directional signal.

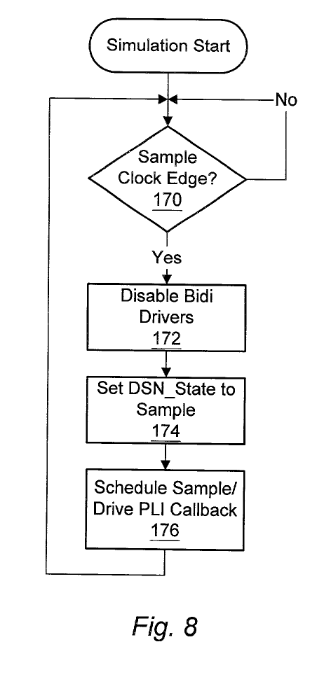

The PLIDone model 56 may be any type of model, similar to the description of the model 20 above. The PLIDone model 56 may, in one embodiment, be coded to perform the functions illustrated in FIGS. 8-10 below.

The simulator 46 may generally be any commercially available simulator for the model 20. The simulator 46 may represent any of the simulators 46A-46D shown in FIG. 2. For example, Verilog embodiments may employ the VCS simulator from Synopsys, the NCVerilog simulator from Cadence, or any other similar Verilog simulator. In one embodiment, the simulator 46 is an event driven simulator, although other embodiments may employ any type of simulator including cycle based simulators.

The simulation control code 32 is configured to interface with the simulator 46, the bidi drivers 48, the PLIDone model 56, the formatter 34, and the parser 36. The simulation control code 32 may include custom simulation code written to interface to the simulator, such as Vera® code which may be called at designated times during a simulation timestep by the simulator. The custom simulation code may include code to react to various grammar commands which may be transmitted to the DSN 30 from the hub. It is noted that the simulation control code 32 may interface to the bidi drivers 48 and the PLIDone model 56 directly or through the simulator 46.

The formatter 34 receives communication requests from the simulation control code 32 and formats the requests according to the grammar for transmission to the hub. In other words, the formatter 34 generates message packets containing commands defined in the grammar based on the communication requests. The parser 36 receives message packets from the socket 38 and parses the commands according to the grammar.

The socket 38 may be a generic Unix socket implementation for communicating with the hub. While one socket 38 is shown with bi-directional communication with the hub, other embodiments may include two independent sockets, each communicating in one direction (sending or receiving) with the hub. Multiple unidirectional or bi-directional sockets may be used, as desired. The socket 38 may also be implemented using other Unix communication methods (e.g. shared memory, pipes, etc.).

The simulation control code 32, the formatter 34, the parser 36, and the socket 38 may together represent one embodiment of an API 54 (e.g. similar to the APIs 54A-54D shown in FIG. 2)

The DDF and POV files 40 and 42 may store the DDF and POV commands for the DSN 30. Specifically, the DDF command may map the physical signals of the model 20 to logical signals specified in the POV command. The POV command may specify the logical signals and port types used by the DSN 30.

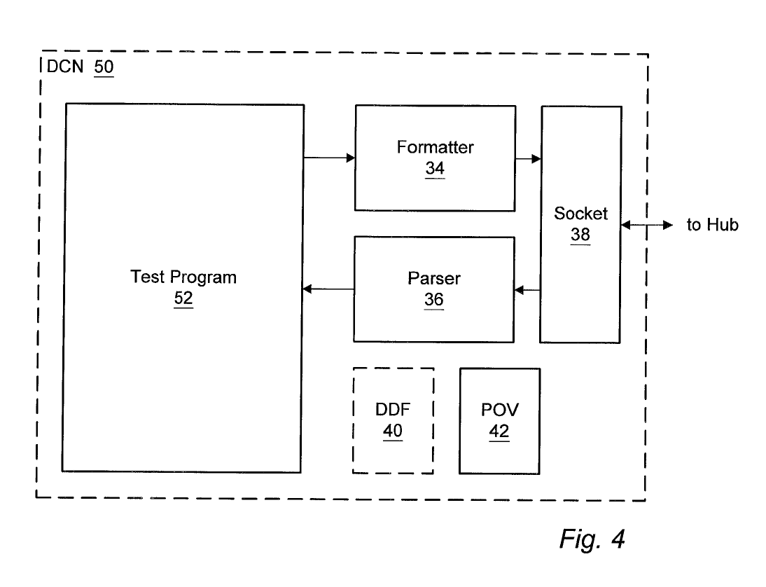

Turning now to FIG. 4, a block diagram of one embodiment of a DCN 50 is shown. The DCN 50 may be an example of the instruction code included in the node 12C shown in FIG. 1. Other embodiments are possible and contemplated. In the embodiment of FIG. 4, the DCN 50 includes a test program 52, the formatter 34, the parser 36, and the socket 38. The DCN 50 may also include the POV file 42 and optionally the DDF file 40. Each of the test program 52, the formatter 34, the parser 36, and the socket 38 comprise instruction sequences for performing various functions. While illustrated separately in FIG. 4, these instruction sequences may be combined, as desired. The illustration in FIG. 4 is a logical partitioning of the function which may not be maintained in the actual program code files, if desired.

The test program 52 may be programmed for any desired test operation. For example, the test program 52 may be configured to inject errors or provide non-error values at a given point or points in the system under test at a given time or times during the simulation. The test program 52 may be configured to transmit the error or non-error value as a transmit command at the given time, formatted by the formatter 34. The test program 52 may be configured to monitor for certain events in the simulation (e.g. by receiving transmit commands from custom code in the desired DSN 30). In general, any desired test operation may be performed by the test program 52.

The POV file 42 is used if the test program 52 transmits or receives signal transmission message packets, for formatting or parsing the packets, respectively. The DDF file 40 is optional, and may be used if the test program 52 creates dummy physical signals for monitoring purposes or other purposes.

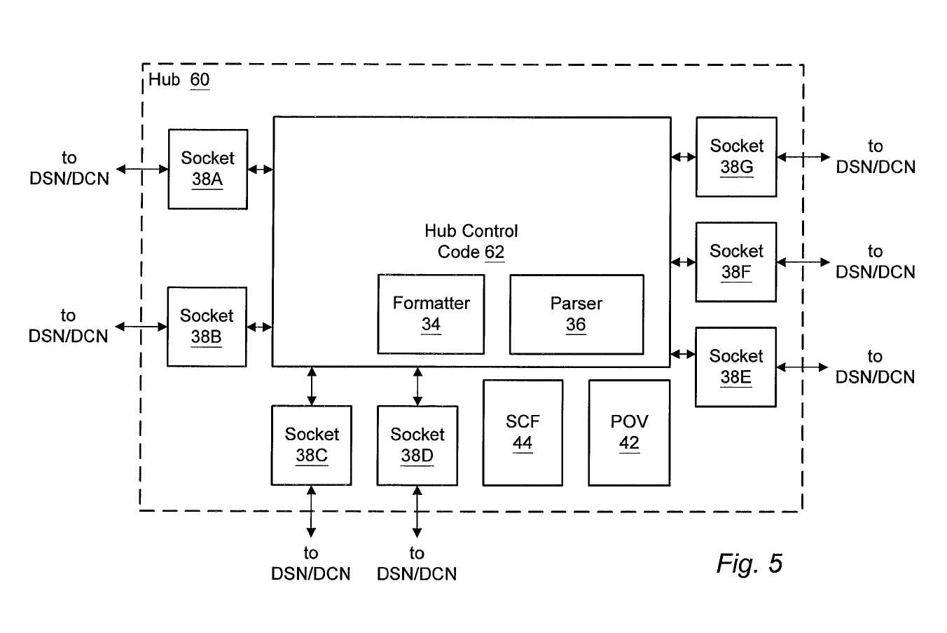

Turning now to FIG. 5, a block diagram of one embodiment of a hub 60 is shown. The hub 60 may be an example of the instruction code included in the node 12E shown in FIG. 1. Other embodiments are possible and contemplated. In the embodiment of FIG. 5, the hub 60 includes a hub control code 62 (which may include the formatter 34 and the parser 36), a set of sockets 38A-38G (the number of which may be equal to the number of DSNs and DCNs, or a multiple of the number if more than one socket is used per node). Additionally, the hub 60 may include the POV file 42 and an SCF file 44. The sockets 38A-38G may each be similar to the socket 38 described above.

The hub control code 62 may generally receive commands from the sockets 38A-38G. The hub control code 62 may process each command, which may result in generating commands for other nodes (or for the source node of the command). For example, transmit commands from a sending DSN may result in one or more transmit commands to other nodes which are connected to the signals. Other types of commands may be used by the hub itself (e.g. for synchronizing the DSNs during the simulation) or may be routed to other nodes (e.g. the user command described in more detail below). The hub control code 62 may use the parser 36 for parsing the received commands and may use the formatter 34 for formatting the commands to be transmitted, in a manner similar to the discussion above for DSNs and DCNs.

In one embodiment, the hub control code 62 may be multithreaded, with a separate thread for each socket. The thread may receive a command from the socket, and invoke the parser 36 to parse the command. The thread may also receive commands from the formatter 34 for transmission on the corresponding socket 38A-38G. The parser 36 and formatter 34 may be shared among the threads, or there may be separate copies of the parser 36 and the formatter 34 for each thread.

Similar to the POV file 42 and the DDF file 40, the SCF file 44 may store the SCF command for the distributed simulation system. The hub control code 62 may use the SCF command to determine which nodes are to be instantiated at the beginning of the simulation, as well as the names of those nodes. The hub control code 62 may further use the routing information in the SCF command for routing signal transmission message packets. That is, the routing information is the information which specifies port connections in the system under test.

Real Time/Zero Time Communication Between Nodes

Each of the DSNs simulates the model of the portion of the system under test assigned to that DSN. The DSN simulates the model as a series of timesteps (e.g. in one embodiment the DSN includes a simulator configured to simulate the model as a series of timesteps) assuming the DSN is performing event-based simulation. Generally, a timestep is the granule of simulation time by which the simulator evaluates events and advances. Simulation time is time measured in the simulation, as opposed to the actual time elapsing to calculate the simulation state during that simulation time. For event based simulators, such as simulators compliant with the IEEE 1364-1995 Verilog specification, the timestep may be any period of simulation time. The processing of all events which occur within a first timestep results in the end of the first timestep. As used herein, the phrase “evaluating the model” or “evaluating the logic” may refer to processing, by the simulator, of each of the then-scheduled events which occur in the current timestep.

The distributed simulation system 10 includes at least a real time phase and may include at least two phases within the simulation timestep: a zero time phase and a real time phase. During the zero time phase, DSNs, DCNs, and the hub may communicate with as many commands as desired (including commands which sample signals from the model or other facilities within the model and commands which change the values of the signals or the values in the facilities within the model) while the simulator is frozen. In other words, the DSNs do not cause the simulator to evaluate the model during the zero time phase (even if the received commands would otherwise cause scheduling of one or more events in the simulator). At the end of the zero time phase, any events scheduled as a result of activities in the zero time phase may be evaluated. As used herein, a facility of a model includes any internal structure or signal of the model which may be modified to cause an event within the model. A facility may also include a structure which monitors a signal or state of the model.

The real time phase includes the sampling and driving of signals from the model and may also include time in which the model is evaluating (e.g. in response to driving input signals in the drive phase). The real time phase may further include evaluation of one or more commands received by the node (e.g. reading or writing model facilities relative to the current real time state). The sample and drive of signals (and a subsequent evaluation of the model) may be iterated multiple times within a timestep. The sampling of signals includes reading the signal values from the model and transmitting one or more transmit commands with the sampled signal values. The driving of signals includes receiving one or more transmit commands with the driven signal values and applying those signal values to the model. The subsequent evaluation of the model determines if the driven signal values cause any changes to signal values within the current timestep (e.g. if the driven signal asynchronously changes an output signal) and may also schedule events for subsequent timestep(s) based on the driven signal values. If any output signals have changed, another phase of sampling and driving may occur. The sampling and driving may be repeated until each DSN does not detect any changes to its output signals in the current timestep, at which time the current timestep may terminate and the next timestep may begin.

In one embodiment, the sampling of signals may include sampling each of the output (and input/output) signals of the model. In another embodiment, the sampling of signals may be accomplished by having the simulator indicate which of the signals have changed value due to event evaluations, and sampling only the signals that have changed. For example, Verilog simulators may support a value change alert (VCA). The VCA may typically be used for monitoring certain signals of interest during a simulation. If a signal changes value and the VCA is set for that signal, the simulator may call a specified function. The distributed simulation system may use the VCA for each output (and input/output) signal to detect changes in the signals, and may sample only those signals which were indicated, via the VCA, as having changed state. Such a system may limit the sampling of signals to only those that have changed state. Still other embodiments may include a mode to select which of the above methods (sampling all signals or sampling only those for which the VCA has indicated a change) is used.

While the embodiments described below include both a zero time phase and a real time phase, other embodiments are contemplated that include only the real time phase (which may include iteration to re-evaluate the model for changes to the input signals from the previous iteration). Additionally, embodiments are contemplated in which both the real time and zero time phases are iterated.

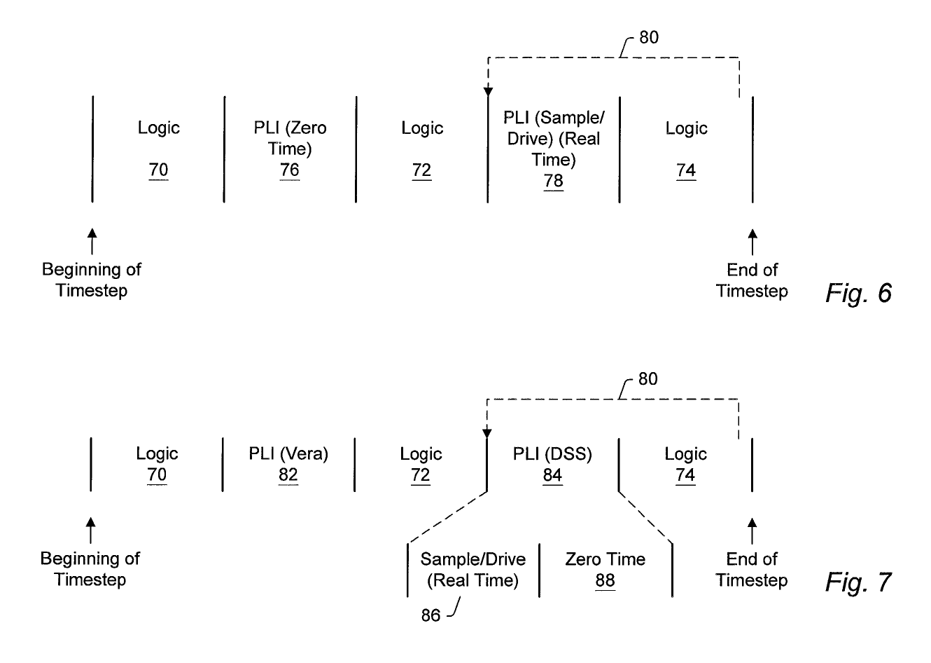

Turning now to FIG. 6, a timing diagram of one embodiment of a timestep is shown. Other embodiments are possible and contemplated. In the embodiment of FIG. 6, the timestep includes several model evaluations (labeled “logic” in FIG. 6 and referred to below as logic evaluations) at reference numerals 70, 72, and 74. Also, a first programming language interface (PLI) call is performed (reference numeral 76), which forms the zero time phase in this embodiment. A second PLI call is made to perform signal sampling and driving (reference numeral 78). The sampling and driving is included in the real time phase, along with the logic evaluations.

In one embodiment, the PLI interface may be compatible with IEEE 1364-1995 standard. Generally, the PLI interface may comprise a set of simulator-defined and/or user-defined functions called by the simulator 46 at certain predefined points within the timestep. The code comprising the functions may be part of the simulation control code 32.

At the beginning of the timestep, the simulator 46 may evaluate all the scheduled events (except possibly the non-blocking assignment events, as described below) occurring within the simulation timestep (logic 70). The simulator 46 may then call the PLI function or functions forming the zero time phase (reference numeral 76). In these functions, any zero time communication that is desired (e.g. testing various model signals/resources and modifying signals/resources) may be performed. The simulator 46 may then evaluate events which may have been scheduled due to zero time operations (if any) (logic 72). For example, the zero time operations may have modified a signal or register value, which results in evaluation events for each sensitive process. After evaluating any zero-time-generated events, the second PLI call (reference numeral 78) to sample output signals (including bi-directional signals) and to drive input signals (including bi-directional signals) is performed. The PLI function or functions may include the communication with the hub (and thus with other nodes) to transmit output signal values and receive input signal values. If new input signal values are driven, the PLI function may communicate to the simulator (e.g. scheduling a callback) that the PLI functions are to be called again after evaluating the events caused by the new input signal values. Repeating the sample/drive call is shown as the dotted arrow 80 in FIG. 6.

The callback may be scheduled each time new signal values are applied to the model. Thus, if an output signal changes within the current timestep (e.g. asynchronously), then the new value of the output signal may be transmitted within the current timestep. Similarly, if an input signal changes asynchronously, the new value of the input signal may be applied to the model during the current timestep (during the next iteration of the sample/drive PLI function). Once a sample/drive sequence occurs in which no input signal changes are applied and no output signal values change, the callback may not be scheduled and the timestep may end (moving to the next timestep).

The embodiment of FIG. 6 performs the zero time phase once per timestep and may iterate the real time phase. Other embodiments are contemplated in which the zero time phase may also be iterated. One such embodiment is shown in FIG. 7. In the embodiment of FIG. 7, the logic evaluations 70, 72, and 74 are included similar to FIG. 6. However, instead of having the zero time phase between the logic evaluations 70 and 72, a PLI call for Vera® test code is provided (reference numeral 82). This PLI call is optional and may be eliminated (along with the logic evaluation 72) in other embodiments. The call to the Vera® test code may typically be provided as shown in FIG. 7. Additionally, a PLI call used by the distributed simulation system (DSS) is provided (reference numeral 84). The PLI call 84 is shown in exploded view and may include both the real time phase sampling and driving the signals of the model (reference numeral 86) and the zero time phase for communicating similar to the reference numeral 76 in FIG. 6 (reference numeral 88). Subsequently, the logic evaluation 74 may occur and the optional callback may be performed (arrow 80) as discussed above. Since both the zero time and real time phases are included in the PLI call 84, both phases are iterated in the embodiment of FIG. 7.

While the embodiment of FIG. 7 illustrates the real time phase followed by the zero time phase within the PLI call 84, other embodiments may have the zero time phase precede the real time phase. Additionally, the iteration of zero time and real time phases may be separate in other embodiments (e.g. a timing diagram similar to FIG. 6 in which there is a callback from the logic evaluation 72 to the zero time PLI call 76).

In one embodiment, the hub may use a synchronous method for synchronizing transitions from the zero time phase to the real time phase and from the real time phase to the end of the timestep in each node. Generally, the hub may receive one command from each node prior to transmitting commands to each node. A node may transmit a NOP command if it has no other command to transmit. If each received command is a NOP command, the nodes have completed the current zero time or real time phase. The hub may transmit a command (e.g. a ZT_Done command for zero time or an RT_Done command for real time) to each node, indicating the completion of the phase. Otherwise, if at least one non-NOP command is received, the hub transmits at least one command to each node (either a command routed from another node or a NOP command) and the hub then waits for commands. Other embodiments may transmit any fixed number of commands per node, or may allow a variable number of commands per node to be transmitted. Still further, a fully asynchronous communication mechanism may be used (with nodes sending commands as desired, and the hub forwarding the commands as received, until each node indicates that it is finished sending commands (e.g. with a local timestep complete command such as ZT_Finish), at which time the hub may transmit an RT_Done or ZT_Done command to each node.

It is noted that, while the above discussion referred to a hub performing the synchronization, other embodiments may not include a hub. Instead, each node may be configured to detect the synchronization by examining the commands received from other nodes (e.g. in a manner similar to the hub). In a daisy chain or ring configuration, a token or other message may be used to communicate the synchronization status.

Non-Blocking Assignments

As mentioned above, the real time phase may be implemented as a PLI call from the simulator program 46. The IEEE 1364-1995 standard is indeterminate as to when the PLI calls are made with respect to the evaluation of non-blocking assignment events. Particularly, the PLI calls may be made either before or after the evaluation of non-blocking assignment events and still be compatible with the IEEE 1364-1995 standard. A non-blocking assignment event is an event which is defined to be processed in the current timestep after the active events and the inactive events within the current timestep. The non-blocking assignment event is an assignment of a signal value to a signal. Thus, the non-blocking assignment event may change the value of a signal, and may generate additional events which change signal values. Output signals may be changed in response to non-blocking assignment events (either directly or indirectly). Thus, transmitting signal values to other nodes prior to the evaluation of non-blocking assignment events may lead to the transmitted signal values being different than the signal values in the DSN node at the end of the timestep. Furthermore, the transmitted signals values in a given timestep may differ depending on the simulator program being used in a given DSN (and whether or not it makes PLI calls before or after the evaluation of non-blocking assignment events).

One embodiment of the DSNs 30 may use the PLIDone model 56 to cause the same simulation behavior in a timestep independent of whether PLI calls are normally made before or after the evaluation of non-blocking assignment events. One embodiment of the PLIDone model 56 is illustrated in FIGS. 8-10. Generally, the PLIDone model 56 includes HDL code which performs a non-blocking assignment and schedules a PLI callback to the sample/drive PLI code in response to the non-blocking assignment. The sample/drive PLI code may trigger the non-blocking assignment by changing the value of a flag (referred to as the PLIDone flag below) on which the non-blocking assignment is performed. In this manner, the PLI call to the sample/drive PLI code is forced to occur after the non-blocking assignment events are evaluated, even if the simulator program 46 would normally perform PLI calls prior to evaluating the non-blocking assignment events. In some instances, more than one non-blocking assignment may need to be evaluated to force the desired scheduling of the PLI call. In one embodiment, the number of non-blocking assignments made may be set by the user. In another embodiment, the simulation control code may automatically detect the number of non-blocking assignments and may configure the PLIDone model 56 accordingly.

Another value referred to in FIGS. 8-10 is the DSN_state. The DSN_state is part of the PLIDone model 56, and may take on one of two values: sample or drive. The DSN_state tracks which of the sample or drive portion of the sample/drive PLI function is being called during the next PLI call (to enable and disable the bidi drivers 48 appropriately).

Turning now to FIG. 8, a flowchart is shown illustrating operation of one embodiment of the first portion of the PLIDone model 56. Other embodiments are possible and contemplated. The portion illustrated in FIG. 8 includes the scheduling of the first PLI call to the sample/drive PLI code within a given timestep.

The portion shown in FIG. 8 relies on a sample clock edge that is synchronized to the underlying timestep of the simulator. Such a sample clock may be included in event-driven simulator models. Alternatively, the portion may schedule events based on the transition of the timesteps instead of using the sample clock. Generally, the portion shown in FIG. 8 waits for the sample clock edge to occur (decision block 170). In response to the sample clock edge, the portion disables the bidi drivers 48 (so that the value being driven on any bi-directional signals by the model 20 may be sampled) (block 172). Additionally, the portion sets the DSN_state to sample (block 174). Finally, the portion schedules the sample/drive PLI callback (block 176). Generally, during initialization, various PLI functions are registered with the simulator 46 (that is, the name of the function and its address are supplied to the simulator 46). The function may be placed in a callback table, which includes a flag indicating if the callback is scheduled. The PLIDone model 56 may schedule a PLI callback by setting the flag corresponding to the function to be called in the callback table.

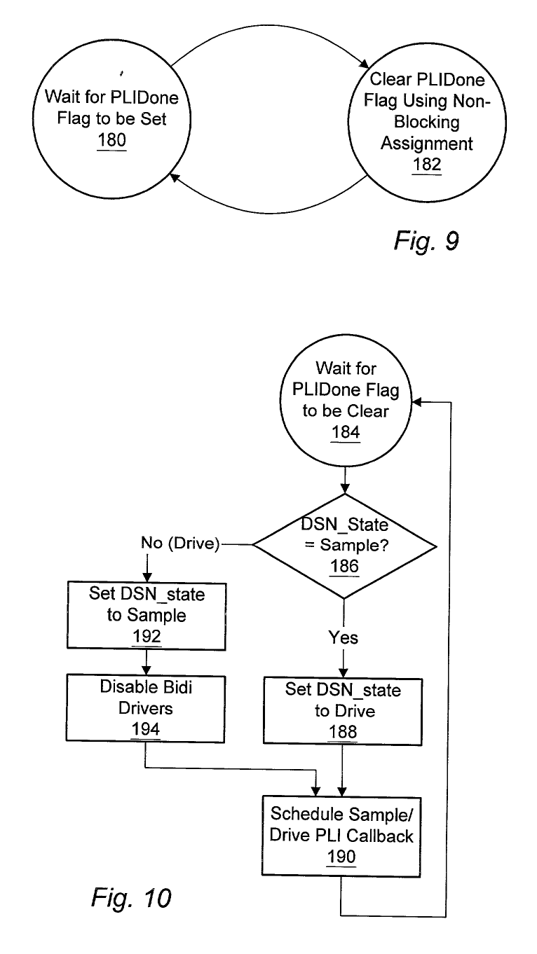

Turning now to FIG. 9, a state machine is shown illustrating operation of one embodiment of a second portion of the PLIDone model 56. Other embodiments are possible and contemplated. The second portion illustrated in FIG. 9 performs a non-blocking assignment on the PLIDone flag.

The state machine includes a first state 180 and a second state 182. In the first state 180, the second portion waits for the PLIDone flag to be set. Particularly, the PLIDone flag may be set by the sample/drive PLI code to trigger a non-blocking assignment on the PLIDone flag. When the PLIDone flag is set, the state machine transitions to the second state 182. In the second state 182, the second portion performs a non-blocking assignment on the PLIDone flag to clear the PLIDone flag. The state machine then returns to the state 180 to await another setting of the PLIDone flag.

It is noted that, while the sample/drive PLI code may set the PLIDone flag and a non-blocking assignment may be used to clear the PLIDone flag, other embodiments may have the sample/drive PLI code clear the PLIDone flag and a non-blocking assignment may be used to set the PLIDone flag. Furthermore, other (e.g. multi-bit) indications may be used as desired. It is noted that the setting and clearing of the PLIDone flag may be iterated any number of times to ensure that all non-blocking assignments have been evaluated.

FIG. 10 is a flowchart illustrating operation of one embodiment of a third portion of the PLIDone model 56. Other embodiments are possible and contemplated. The portion illustrated in FIG. 10 includes the scheduling of the PLI call to the sample/drive PLI code responsive to the non-blocking assignment.

The third portion of the PLIDone model 56 is triggered by the evaluation of the non-blocking assignment on the PLIDone flag (block 184). In other words, the third portion is scheduled as an event in response to evaluating the non-blocking assignment scheduled by the second portion of the PLIDone model 56.

In response to the clearing of the PLIDone flag, the third portion examines the DSN_state (decision block 186). If the DSN_state is sample, the third portion sets the DSN_state to drive (block 188). If the DSN_state is drive, the third portion sets the DSN_state to sample (block 192) and disables the bidi drivers 48 (block 194). The bidi drivers 48 may be disabled to allow sampling of the value driven by the model 20 on the bi-directional signals (e.g. unaffected by any value that may be driven by the bidi drivers 48). In the present embodiment, the bidi drivers 48 may be enabled in the sample/drive PLI code. In either DSN_state, the third portion schedules the callback to the sample/drive PLI code (block 190) and waits for the PLIDone flag to be cleared again.

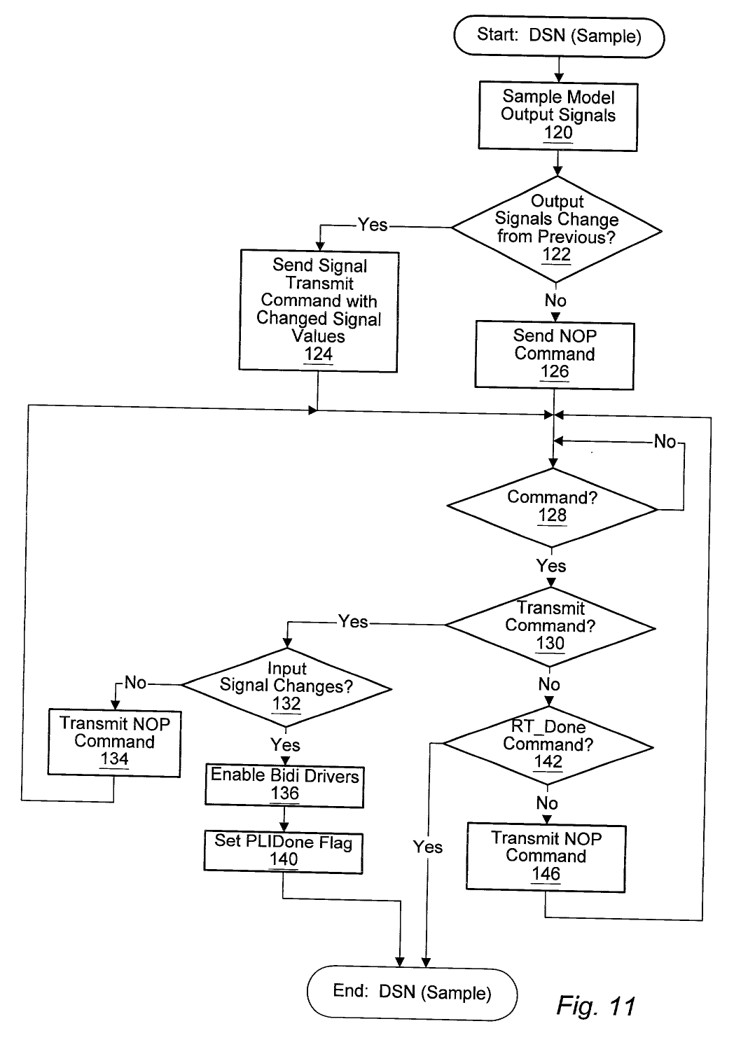

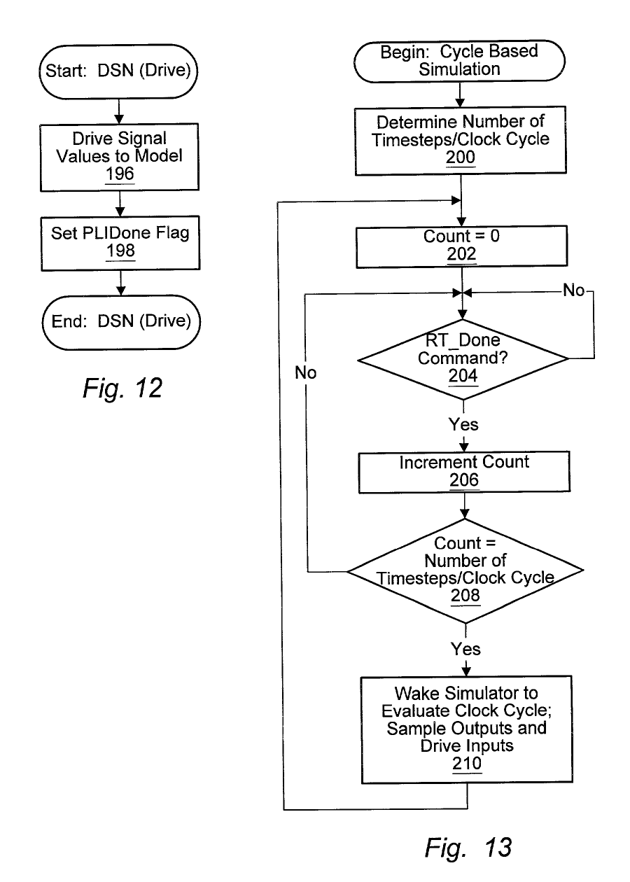

FIGS. 11 and 12 are flowcharts illustrating operation of one embodiment of the sample/drive PLI code (which may be part of the simulation control code 32) during the sample and the drive portion of the real time phase, respectively. In one embodiment, the callback to the sample/drive PLI code may be a single entry point which determines whether the sample portion or the drive portion of the real time phase is being performed (e.g. via a variable maintained by the code or alternatively by reading the DSN_state) and may branch to code implementing the flowcharts of FIG. 11 or 12. Alternatively, the third portion of the PLIDone model 56 may separately schedule the functions depending on the DSN_state.

The flowchart of FIG. 11 refers to various commands that may be defined in the grammar used by the distributed simulation system 10. Specifically, the transmit command used to transmit signal values (described above) is referred to, as well as a NOP command and an RT Done command. The NOP command is a no-operation command (i.e. no operation is expected to be performed in response to the command). The NOP command may be sent when no other command is needed, to signal that the node is not receiving any communication or sending any communication at this time. The RT Done command may be used by the hub to signal the end of the real time phase (and thus signalling progression to the next time step).

Turning next to FIG. 11, a flowchart is shown illustrating operation of one embodiment of the DSN 30 (and more particularly the simulation control code 32, for the embodiment of FIG. 3) during the sample portion of the real time phase of a timestep. Other embodiments are possible and contemplated. While the blocks are shown in FIG. 11 in a particular order for ease of understanding, other orders may be used. Furthermore, blocks may be performed in parallel. The blocks shown in FIG. 11 may represent instruction code which, when executed, performs the blocks shown in FIG. 11.

The DSN 30 samples the model output signals (block 120). Generally, the sampling of the output signals may include interfacing to the model 20 (either directly or through the simulator 46) to retrieve the output signal values. In one embodiment, the simulator 46 may support certain function calls from the PLI for retrieving signal values. The list of output signals (including bi-directional signals) may be extracted from the model as part of initializing the simulation, and the list may be used to extract the signal values.

The DSN 30 compares the sampled output signal values to previously sampled output signal values to detect if any output signal values have changed from the previous sample (decision block 122). If one or more output signal values have changed, the DSN 30 transmits a transmit command with the changed signal values (block 124). Otherwise, the DSN 30 transmits a NOP command (block 126).

The DSN 30 waits to receive a command (decision block 128). The waiting may be accomplished in a variety of fashions. For example, the decision block 128 may represent polling for a command, or may represent the DSN 30 being inactive (“asleep”) until the command is received.

If the received command is a transmit command (decision block 130), the DSN 30 examines the input signals and values provided in the transmit command to determine if any input signals to the model 20 have changed from previously driven values (decision block 132). If no changes are detected, the DSN 30 may transmit a NOP command and wait for additional commands to be sent (block 134). In this manner, evaluating the model and iterating the sample/drive sequence may be avoided in cases in which the signal values are not changed (and thus the evaluation of the model would result in no output signal changes). The DSN 30 waits for additional commands since, if a transmit command has been received, another node may be evaluating its model and may transmit an updated signal value for one or more input signals of the model 20. It is noted that, in some embodiments, checking for input signal changes may not be performed (e.g. the model may be evaluated and the sample/drive sequence may be iterated in response to receiving transmit commands which include no input signal changes for the model 20).

If the transmit command does include one or more input signal value changes, the DSN 30 may enable the bidi drivers 48 (to allow for any bi-directional signal changes to be driven onto the bi-directional signals) (block 136). The DSN 30 may supply the input signal values to the simulator 46 for driving on the input signals (or to the bidi drivers 48 for bi-directional signals). The DSN 30 may also set the PLIDone flag, to trigger the non-blocking assignment of the PLIDone flag and thus to schedule a callback to sample/drive PLI code. When the callback occurs, the drive code may be executed, supplying the input signals to the model 20 (block 140). The code may then exit to allow the simulator 46 to evaluate the model. The exit in this case may be performed to turn on (enable) the bidi drivers 48 in the simulation prior to supplying the values to be driven by the bidi drivers. This exit is optional and may be eliminated in other embodiments (e.g. other embodiments may drive the signals corresponding to the drive portion of the PLI call and then exit to allow the simulator to evaluate any new events).

If the command is not a transmit command, the DSN 30 determines if the command is the RT_Done command signaling the end of the real time phase of the timestep (decision block 142). The code may then exit (to be called again at the PLI stage in the next timestep). Since the PLIDone flag is not set in this case, no callback may occur and the timestep may end.

If the command is not the RT_Done command, the command may be a NOP. The DSN 30 may transmit a NOP command (block 146) and wait for another command.

Turning next to FIG. 12, a flowchart is shown illustrating operation of one embodiment of the DSN 30 (and more particularly the simulation control code 32, for the embodiment of FIG. 3) during the drive portion of the real time phase of a timestep. Other embodiments are possible and contemplated. While the blocks are shown in FIG. 12 in a particular order for ease of understanding, other orders may be used. Furthermore, blocks may be performed in parallel. The blocks shown in FIG. 12 may represent instruction code which, when executed, performs the blocks shown in FIG. 12.

The DSN 30 drives the received signal values to the model 20 (block 196). The driving of the signal values may be direct, or indirect through the simulator 46. Additionally, the DSN 30 sets the PLIDone flag (block 198). By setting the PLIDone flag, a callback is scheduled for the sample portion of the sample/drive PLI code (and thus the real time phase is iterated).

Turning now to FIG. 13, a flowchart is shown illustrating operation of one embodiment of the DSN 30 (and more particularly the simulation control code 32, for the embodiment of FIG. 3) when the simulator 46 is a cycle-based simulator. Other embodiments are possible and contemplated. While the blocks are shown in FIG. 13 in a particular order for ease of understanding, other orders may be used. Furthermore, blocks may be performed in parallel. The blocks shown in FIG. 13 may represent instruction code which, when executed, performs the blocks shown in FIG. 13.

During the initialization of the simulation, the DSN 30 may determine the number of timesteps (used by the other nodes in the distributed simulation which are simulating using event-based simulators) which correspond to a clock cycle of the clock in the cycle-based simulation being performed in the DSN 30 (block 200). That is, the time interval represented by the number of timesteps is equal to the period of the clock cycle.

The DSN 30 initializes a count to zero (block 202) and then begins monitoring for RT_Done commands indicating the completion of each timestep (decision block 204). Generally, the decision block 204 may represent receiving commands from the hub, including transmit commands from other nodes, if applicable. If a transmit command is received, the DSN 30 may retain the supplied signal values for driving to the model when the next evaluation of the model is scheduled. If a subsequent value is supplied for the same signal, the subsequently supplied value may override the previous value. Alternatively, the DSN 30 may attempt to resolve the received values in accordance with the IEEE 1364-1995 specification. The DSN 30 may transmit a NOP command in response to receiving either a transmit command or a NOP command.

If an RT_Done command is received, the current timestep is complete. Thus, the DSN 30 may increment the count (block 206). The DSN 30 may test the incremented count to determine if the number of counted timesteps equals the number of timesteps/clock cycle determined in block 200 (decision block 208). If not, the DSN 30 may return to block 204 to wait for additional RT_Done commands. On the other hand, if the count does equal the number of timesteps/clock cycle, the DSN 30 may “wake” the cycle-based simulator 46 to evaluate the model. The DSN 30 may drive inputs to the model prior to evaluating the model based on received transmit messages and may sample outputs to generate transmit messages to other nodes to communicate the generated outputs from the model 20 (block 210). The DSN 30 may then clear the count (block 202) and begin waiting for the RT_Done commands again.

Accordingly, the DSN 30 illustrated in FIG. 13 causes the cycle-based simulation to evaluate once every “N” timesteps, where N is the number of timesteps equaling a period of the clock cycle.

Exemplary Grammar

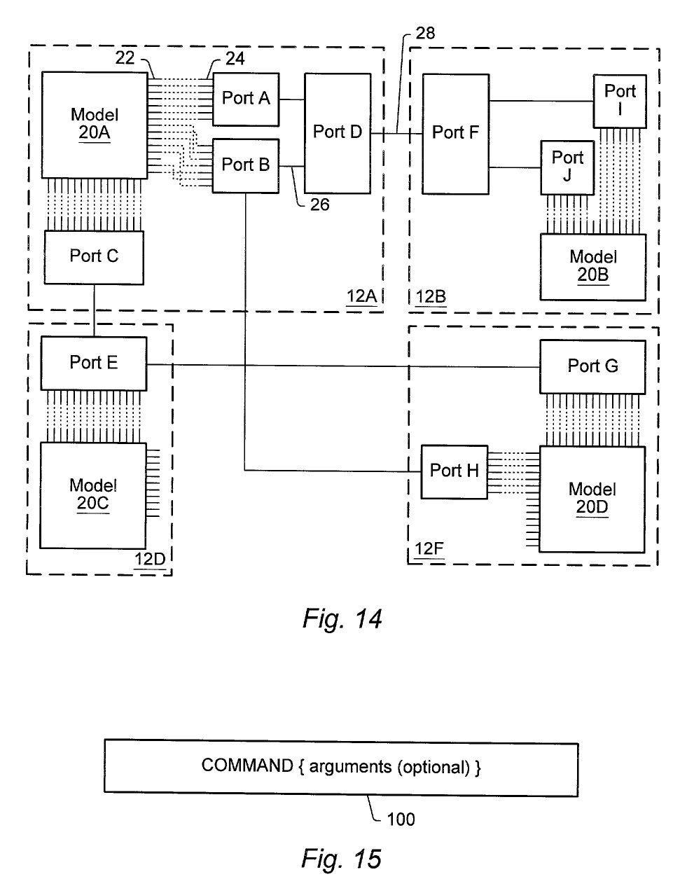

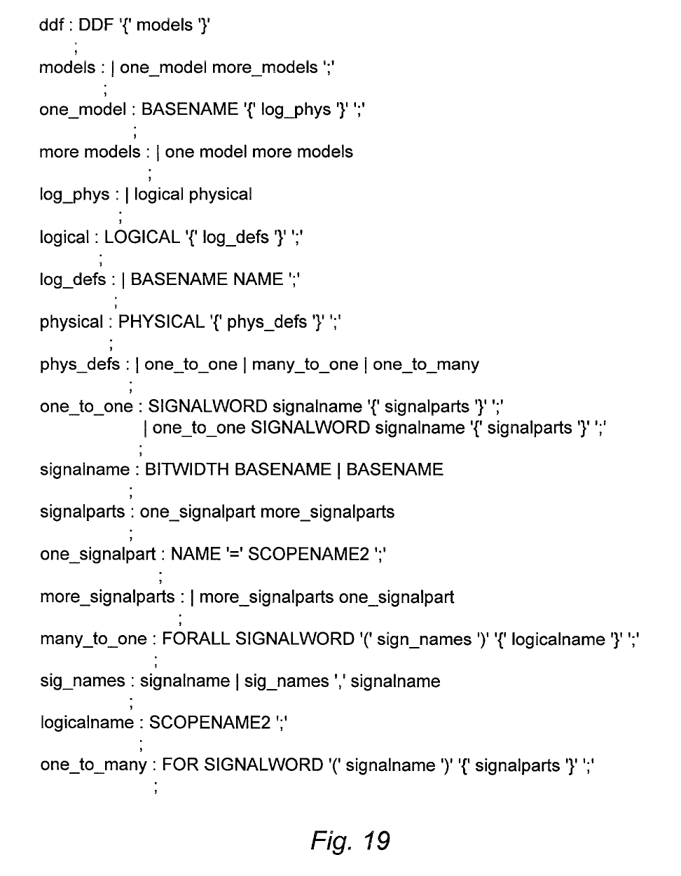

Turning next to FIGS. 14-25, an example of a grammar which may be used in one embodiment of the distributed simulation system 10 is shown. Other embodiments are possible and contemplated, including subsets or supersets of the grammar illustrated.

FIG. 14 is a block diagram illustrating the use of logical signals and logical ports for the nodes shown in FIG. 2. Each model may be in the corresponding node 12A, 12B, 12D and 12F, indicated by the dashed enclosures shown in FIG. 14. Specifically, the node 12A is simulating the model 20A for which ports A-D are defined; the node 12B is simulating the model 20B for which ports F, I and J are defined; the node 12D is simulating a model 20C for which port E is defined, and the node 12F is simulating a model 20D for which ports G-H are defined. Ports A-B are subports of port D (i.e. port D is a port including ports A and B, each of which include logical signals).

Each of the models 20A-20D include physical signals, represented as solid lines emanating from the models 20A-20D (e.g. reference numeral 22 is a physical signal from the model 20A). Each of the ports A-J include other ports or logical signals, represented as solid lines emanating from the ports A-J (e.g. reference numeral 24 is a logical signal from the port A and reference numeral 26 is a solid line evidencing the inclusion of port B in port D). Solid lines between nodes (e.g. reference numeral 28 between port D and port F) indicate port connections between the nodes. The dotted lines between physical signals and logical signals indicate mappings of physical signals to logical signals (e.g. the dotted line between the physical signal 22 and the logical signal 24 illustrates the mapping of the physical signal 22 to the logical signal 24).

The physical signals output by the models may be mapped to logical signals using one or more DDF commands, as illustrated by the dotted lines between physical signals and logical signals. Thus, DDF commands may map: (i) the physical signals from the model 20A to the logical signals of ports A, B, and C; (ii) the physical signals from the model 20B to the logical signals of ports I and J; (iii) the physical signals from the model 20C to the logical signals of port E; and (iv) the physical signals from the model 20D to the logical signals of ports G and H. The logical signals and logical port types (including port types corresponding to the hierarchical ports D and F) may be defined in one or more POV commands. Finally, the connections between ports from different nodes may be defined in one or more SCF commands. Particularly, SCF commands may specify connections between port D and port F, port B and port H, and port E to both ports C and G. Together, the DDF, POV, and SCF commands thus describe a system structure.

The logical signals corresponding to a given model may have a different bit order than the corresponding physical signals. Additionally, the physical signals may be divided into multiple logical signals, as desired.

FIG. 14 also illustrates that a port may be both a subport of a higher level port and may be connected to a port in another node. For example, port B may be connected to port H, and may also be a subport of port D.

Turning next to FIG. 15, a block diagram of a message packet 100 is shown. Other embodiments are possible and contemplated. Generally, a message packet is a packet including one or more commands and any arguments of each command. The message packet may be encoded in any fashion (e.g. binary, text, etc.). In one embodiment, a message packet is a string of characters.

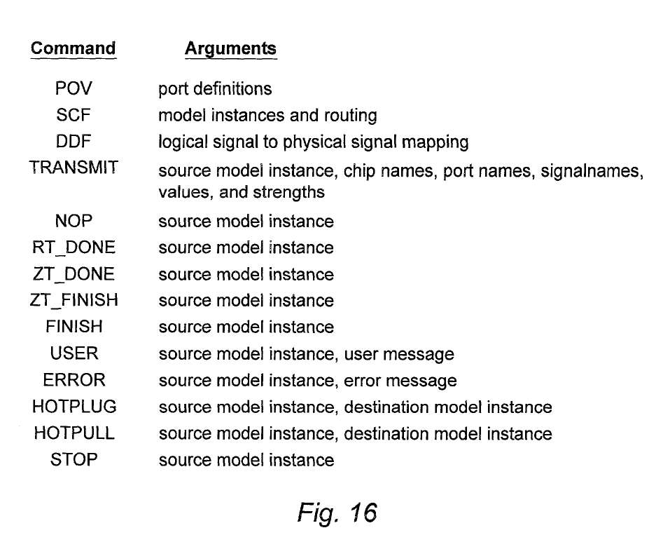

The message packet may comprise one or more characters defined to be a command (“COMMAND” in FIG. 15), followed by an opening separator character (defined to be an open brace in this embodiment, but any character may be used), followed by optional arguments, followed by a closing separator character (defined to be a close brace in this embodiment, but any character may be used). In Backus-Naur form (BNF), the packet may be described as: COMMAND “{” arguments “}”. COMMAND is a token comprising any string of characters which is defined to be a command. A list of commands are illustrated in FIG. 16 for an exemplary embodiment. Arguments are defined as: | arguments one_argument. One_argument has a definition which depends on the command type.

It is noted that, when BNF definitions are used herein, words shown in upper case are tokens for the lexer used in the generation of the parser while words shown in lower case are terms defined in other BNF expressions.

FIG. 16 is a table illustrating an exemplary set of commands and the arguments allowed for each command. Other embodiments may include other command sets, including subsets and supersets of the list in FIG. 16. Under the Command column is the string of characters used in the message packet to identify the command. Under the Arguments column is the list of arguments which may be included in the command.

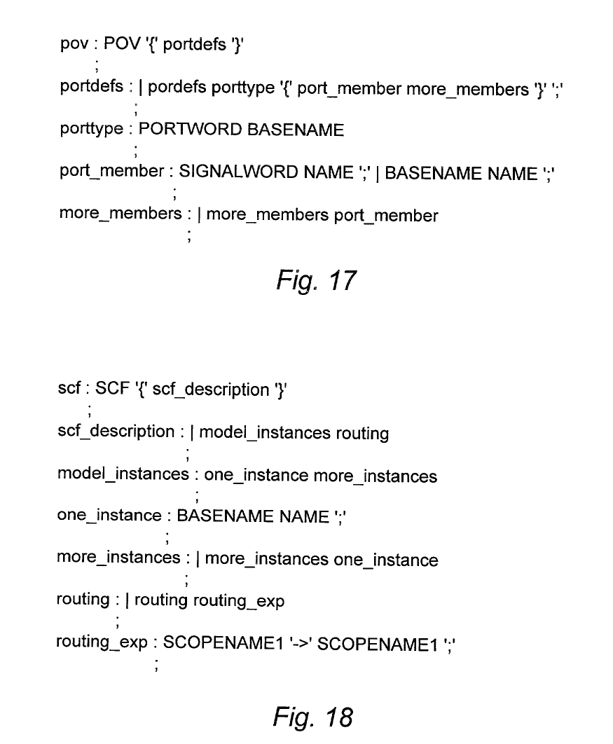

The POV, SCF, and DDF commands have been introduced in the above description. Additionally, FIGS. 17-19 below provide descriptions of these commands in BNF. Generally, the POV command has the port type definitions as its arguments; the SCF command has model instances (i.e. the names of the models in each of the DSNs) and routing expressions as its arguments; and the DDF command has logical signal to physical signal mappings as its arguments. These commands will be described in more detail below with regard to FIGS. 17-19.

The TRANSMIT command is used to transmit signal values from one port to another. That is, the TRANSMIT command is the signal transmission message packet in the distributed simulation system. Generally, the transmit command includes the name of the model for which the signals are being transmitted (which is the model name of the source of the signals, for a packet transmitted from a DSN/DCN to the hub, or the model name of the receiver of the signals, for a packet transmitted by the hub to a DSN/DCN), one or more ports in the port hierarchy, logical signal names, and assignments of values to those signal names. For example, the TRANSMIT command may be formed as follows:

TRANSMIT{model {port{signalname={value=INT;strength=POTENCY;};}}}

Where the port may include one or more subports (e.g. port may be port{subport, repeating subport as many times as needed to represent the hierarchy of ports until the logical signal names are encountered). Additional closing braces would be added at the end to match the subport open braces. The TRANSMIT command may be represented in BNF as follows:

```
transmit:TRANSMIT ‘{‘chip‘{‘ports’}’’}’
      ;
chip:chipportname
    ;
ports:|ports chipportname‘{‘ ports data’}’
    ;
chipportname:PORT
          ;
data:|data dataline ports
    ;
dataline:NAME ‘=’‘{‘signalparts’}’
      ;
signalparts:VALUE ‘=’ INT ‘;’
        |VALUE ‘=’ INT ‘;’ STRENGTH ‘=’ POTENCY ‘;’
        |VALUE ‘=’ BIN ‘;’
        |VALUE ‘=’ BIN ‘;’ STRENGTH ‘=’ POTENCY ‘;’
        |VALUE ‘=’ HEX ‘;’
        |VALUE ‘=’ HEX ‘;’ STRENGTH ‘=’ POTENCY ‘;’
        ;
```

where the following are the token definitions: TRANSMIT is the “TRANSMIT” keyword, PORT is a port type defined in the POV command (preceded, in one embodiment, by a period), NAME is a logical signal name, VALUE is the “value” keyword, INT is an integer number, BIN is a binary number, and HEX is a hexadecimal number, STRENGTH is the “strength” keyword, and POTENCY is any valid signal strength as defined in the HDL being used (although the actual representation of the strength may vary).

The signal strength may be used to simulate conditions in which more than one source may be driving a signal at the same time. For example, boards frequently include pull up or pull down resistors to provide values on signals that may not be actively driven (e.g. high impedance) all the time. An active drive on the signal may overcome the pull up or pull down. To simulate such situations, signal strengths may be used. The pull up may be given a weak strength, such that an active drive (given a strong strength) may produce a desired value even though the weak pull up or pull down is also driving the same signal. Thus signal strength is a relative indication of the ability to drive a signal to a desired value. In one embodiment, the signal strengths may include the strengths specified by the IEEE 1364-1995 standard. For example, the strengths may include (in order of strength from strongest to weakest): supply drive, strong drive, pull drive, large capacitor, weak drive, medium capacitor, small capacitor and high impedance. The strengths may also include the 65×strength (an unknown value with a strong driving 0 component and a pull driving 1 component) and a 520 strength (a 0 value with a range of possible strengths from pull driving to medium capacitor).

The NOP command is defined to do nothing. The NOP command may be used as an acknowledgment of other commands, to indicate completion of such commands, for synchronization purposes, etc. The NOP command may have a source model instance argument in the present embodiment, although other embodiments may include a NOP command that has no arguments or other arguments The NOP command may also allow for reduced message traffic in the system, since a node may send a NOP command instead of a transmit command when there is no change in the output signal values within the node, for example.

The RT_DONE, ZT_DONE, ZT_FINISH, and FINISH commands may be used to transition DSNs between two phases of operation in the distributed simulation system, for one embodiment. In this embodiment, each simulator timestep includes a real time phase and a zero time phase. In the real time phase, simulator time advances within the timestep. In the zero time phase, simulator time is frozen. Messages, including TRANSMIT commands, may be performed in either phase. The RT_DONE command is used by the hub to signal the end of a real time phase, and the ZT_DONE command is used by the hub to indicate that a zero time phase is done. The ZT_FINISH command is used by the DSN/DCN nodes to signal the end of a zero time phase in asynchronous embodiments of zero time. The FINISH command is used to indicate that the simulation is complete. Each of the RT_DONE, ZT_DONE, ZT_FINISH, and FINISH commands may include a source model instance argument.

The USER command may be used to pass user-defined messages between nodes. The USER command may provide flexibility to allow the user to accomplish simulation goals even if the communication used to meet the goals is not directly provided by commands defined in the grammar. The arguments of the USER command may include a source model instance and a string of characters comprising the user message. The user message may be code to be executed by the receiving node (e.g. C, Vera®, Verilog, etc.), or may be a text message to be interpreted by program code executing at the receiving node, as desired. In one embodiment, the routing for the USER command is part of the user message.

The ERROR command may be used to provide an error message, with the text of the error message and a source model instance being arguments of the command.

The HOTPLUG and HOTPULL commands may be used to simulate the hot plugging or hot pulling of a component. A component is “hot plugged” if it is inserted into the system under test while the system under test is powered up (i.e. the system under test, when built as a hardware system, is not turned off prior to inserting the component). A component is “hot pulled” if it is removed from the system under test while the system is powered up. A node receiving the HOTPLUG command may begin transmitting and receiving message packets within the distributed simulation system. A node receiving the HOTPULL command may cease transmitting message packets or responding to any message packets that may be sent to the node by other nodes. The HOTPLUG and HOTPULL commands may include a source model instance argument and a destination model instance argument (where the destination model instance corresponds to the component being hot plugged or hot pulled).

The STOP command may be used to pause the simulation (that is, to freeze the simulation state but not to end the simulation). The STOP command may include a source model instance argument.

FIGS. 17-19 are BNF descriptions of the POV, SCF, and DDF commands, respectively, for one embodiment of the grammar. Other embodiments are possible and contemplated. As mentioned above, the words shown in upper case are tokens for the lexer used in the generation of the parser while words shown in lower case are terms defined in other BNF expressions.

Generally, the POV command includes one or more port type definitions. In the present embodiment, the POV command includes two data types: ports and signals. Signals are defined within ports, and ports may be members of other ports. The signal is a user defined logical signal, and the port is a grouping of other ports and/or signals. Each port type definition begins with the “port” keyword, followed by the name of the port, followed by a brace-enclosed list of port members (which may be other ports or signals). Signals are denoted in a port definition by the keyword “signal”. Ports are denoted in a port definition by using the port name, followed by another name used to reference that port within the higher level port.

The SCF command includes an enumeration of the model instances within the system under test (each of which becomes a DSN or DCN in the distributed simulation system) and a set of routing expressions which define the connections between the logical ports of the model instances. The model instances are declared using a model type followed by a name for the model instance. A DDF command is provided for the model type to define its physical signal to logical signal mapping. The model name is used in the TRANSMIT commands, as well as in the routing expressions within the SCF command. Each routing expression names a source port and a destination port. TRANSMIT commands are routed from the source port to the destination port. The port name in these expressions is hierarchical, beginning with the model instance name and using a “.” as the access operator for accessing the next level in the hierarchy. Thus, a minimum port specification in a routing expression is of the form model_name.port_name1. A routing expression for routing the port_name2 subport of port_name1 uses model_name.port_name1.port_name2. In this example, a routing expression of the form model_name.port_name1 may route any signals encompassed by port_name1 (including those within port_name2). On the other hand, a routing expression of the form model_name.port_name1.port_name2 routes only the signals encompassed by port_name2 (and not other signals encompassed by port_name1 but not port_name2). The routing operator is defined, in this embodiment, to be “−>” where the source port is on the left side of the routing operator and the destination port is on the right side of the routing operator.

In the SCF command, bi-directional ports may be created using two routing expressions. The first routing expression routes the first port (as a source port) to the second port (as a destination port) and the second routing expression routes the second port (as a source port) to the first port (as a destination port). Additionally, a single port may be routed to two or more destination ports using multiple routine expressions with the single port as the source port and one of the desired destination ports as the destination port of the routing expression.

As mentioned above, the DDF command specifies the physical signal to logical signal mapping for each model type. In the present embodiment, the DDF command is divided into logical and physical sections. The logical section enumerates the logical ports used by the model type. The same port type may be instantiated more than once, with different port instance names. The physical section maps physical signal names to the logical signals defined in the logical ports enumerated in the logical section. In one embodiment, the DDF command provides for three different types of signal mappings: one-to-one, one-to-many, and many-to-one. In a one-to-one mapping, each physical signal is mapped to one logical signal. In a one-to-many mapping, one physical signal is mapped to more than one logical signal. The “for” keyword is used to define a one-to-many mapping. One-to-many mappings may be used if the physical signal is an output. In a many-to-one mapping, more than one physical signal is mapped to the same logical signal. The “forall” keyword is used to define a many-to-one mapping. Many-to-one mappings may be used if the physical signals are inputs.

The DDF commands allow for the flexibility of mapping portions of multi-bit signals to different logical signals (and not mapping portions of multi-bit physical signals at all). The signalpart type is defined to support this. A signalpart is the left side of a physical signal to logical signal assignment in the physical section of a DDF command. If a portion of a multi-bit physical signal, or a logical signal, is not mapped in a given DDF command, a default mapping is assigned to ensure that each physical and logical signal is assigned (even though the assignment isn't used). The “default logical” keyword is used to define the default mappings of logical signals not connected to a physical signal.

For the BNF descriptions in FIGS. 17-19, the tokens shown have the following definitions: POV is the “POV” command name; PORTWORD is the “port” keyword; NAME is a legal HDL signal name, including the bit index portion (e.g. [x:y] or [z], where x, y, and z are numbers, in a Verilog embodiment) if the signal includes more than one bit; BASENAME is the same as NAME but excludes the bit index portion; SIGNALWORD is the “signal” or “signals” keywords; SCF is the “SCF” command name; SCOPENAME1 is a scoped name using BASENAMES (e.g. BASENAME.BASENAME.BASENAME); DDF is the “DDF” command name; LOGICAL is the “logical” keyword; PHYSICAL is the “physical” keyword; BITWIDTH is the bit index portion of a signal; FORALL is the “forall” keyword; “FOR” is the “for” keyword; and SCOPENAME2 is scoped name using NAMES (e.g. NAME.NAME.NAME).

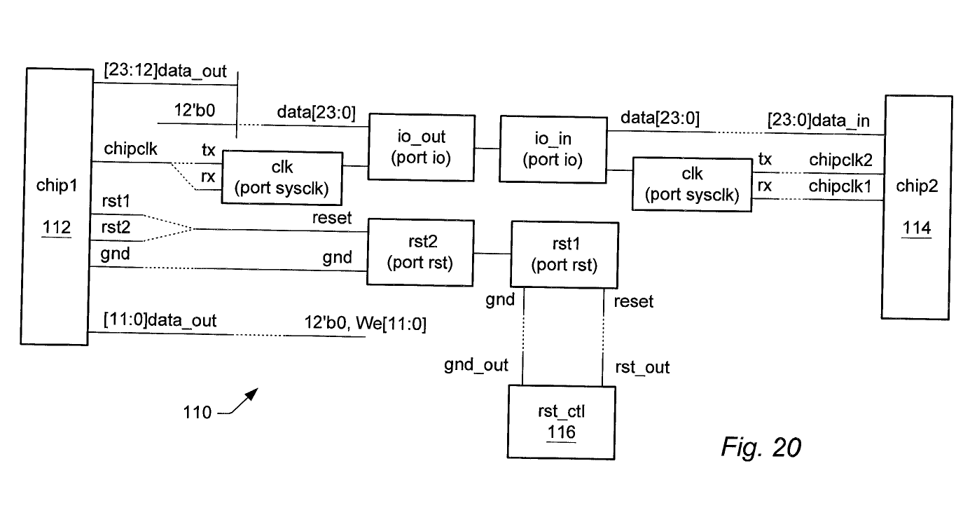

FIGS. 20-25 illustrate an exemplary system under test 110 and a set of POV, DDF, and SCF commands for creating a distributed simulation system for the system under test. In the example, the system under test 110 includes a first chip (chip 1) 112, a second chip (chip 2) 114, and a reset controller circuit (rst_ctl) 116. Each of the chip 1 112, the chip 2 114, and the rst_ctl 116 may be represented by separate HDL models (or other types of models). The signal format used in FIGS. 20-25 is the Verilog format, although other formats may be used.

The chip 1 112 includes a data output signal ([23:0]data out), a clock output signal (chipclk), two reset inputs (rst1 and rst2), and a ground input (gnd). The chip 2 114 includes a data input signal ([23:0]data_in) and two clock input signals (chipclk1 and chipclk2). The rst_ctl 116 provides a ground output signal (gnd_out) and a reset output signal (rst_out). All of the signals in this paragraph are physical signals.

Several ports are defined in the example. Specifically, the port types io, sysclk, and rst are defined. The sysclk port type is a subport of the io port type, and has two logical signal members (tx and rx). The io port type has a clk subport of the sysclk port type and a data signal (having 24 bits) as a member. Two instantiations of io port type are provided (io_out and io_in), and two instantiations of the rst port type are provided (rst1 and rst2). In this example, the port io_out is routed to the port io_in and the port rst1 is routed to the port rst2.

In this example, only the most significant 12 bits of the data output signal of the chip 1 112 are routed to other components (specifically, the chip2 114). Thus, the most significant 12 bits of the data output signal are mapped to the most significant bits of the logical signal data[23:0] of the port io_out. The least significant bits are assigned binary zeros as a default mapping, although any value could be used. The chipclk signal of chip1 112 is mapped to both the logical clock signals tx and rx of the port clk. The rst1 and rst2 input signals of chip 1 112 are both mapped to the reset logical signal of the port rst2. The gnd input signal is mapped to the gnd logical signal of the rst2 port.

The data input signal of the chip 2 114 is mapped to the data[23:0] logical signal of port io_in. The chipclk1 signal is mapped to the rx logical signal of the port clk, and the chipclk2 signal is mapped to the tx logical signal of the port clk. Finally, the gnd_out signal of rst_ctl 116 is mapped to the gnd logical signal of port rst1 and the rst_out signal of rst_ctl 116 is mapped to the reset logical signal of port rst1.

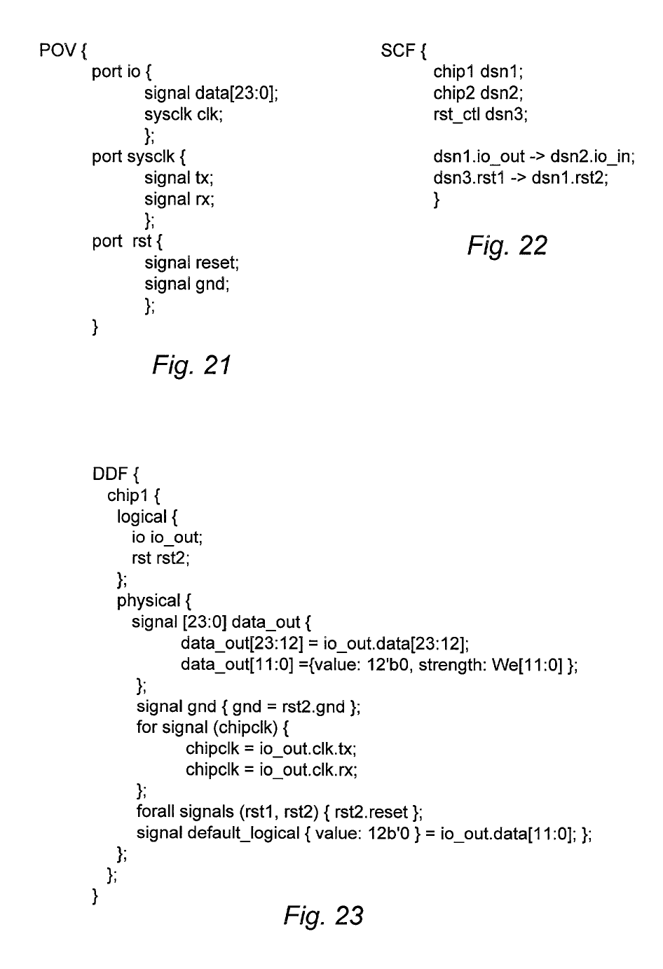

FIG. 21 is an example POV command for the system under test 110. The POV command defines the three port types (io, sysclk, and rst), and the logical signals included in each port type. Port type io includes the logical signal data[23:0] and the subport clk of port type sysclock. Port type sysclock includes the logical signals tx and rx; and the port type rst includes logical signals reset and gnd.

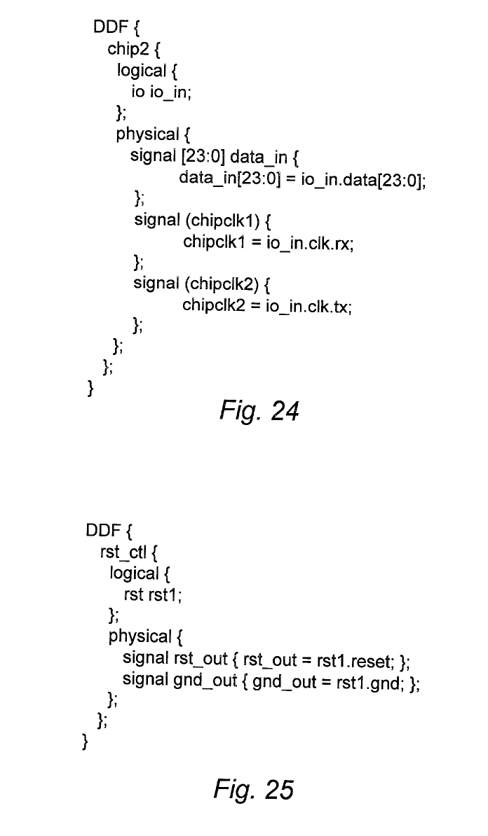

FIG. 22 is an example SCF command for the system under test 110. The SCF file declares three model instances: dsn1 of model type chip1 (for which the DDF command is shown in FIG. 23); dsn2 of model type chip2 (for which the DDF command is shown in FIG. 24); and dsn3 of model type rst_ctl (for which the DDF command is shown in FIG. 25). Additionally, the SCF command includes two routing expressions. The first routing expression (dsn1.io_out−>dsn2.io_in) routes the io_out port of model dsn1 to the io_in port of model dsn2. The second routing expression (dsn3.rst1−>dsn1.rst2) routes the rst1 port of dsn3 to the rst2 port of dsn1.

Thus, for example, a transmit command received from dsn3 as follows:

TRANSMIT{.dsn3{.rst1{gnd={value=0;}; reset={value=1;};}}};

causes the hub to generate a transmit command to dsn1 (due to the second routing expression, by substituting dsn1 and rst2 for dsn3 and rst1, respectively):

TRANSMIT{.dsn1{.rst2{gnd={value=0;}; reset={value=1;};}}};

As mentioned above, the parser in the hub may parse the transmit command received from dsn3 and may route the logical signals using the child-sibling trees and hash table, and the formatter may construct the command to dsn1.

In the DDF command for chip1 (FIG. 23), the logical section instantiates two logical ports (io_out of port type io, and rst2 of port type rst). The physical section includes a one-to-one mapping of the data output signal in two parts: the most significant 12 bits and the least significant 12 bits. The most significant 12 bits are mapped to the logical signal io_out.data[23:12]. The least significant 12 bits are mapped to the weak binary zero signals. A one-to-one mapping of the physical signal gnd to the logical signal rst2.gnd is included as well.

The physical section also includes a one-to-many mapping for the chipclk signal. The keyword “for” is used to signify the one-to-many mapping, and the assignments within the braces map the chipclk signal to both the logical signals in the clk subport: io_out.clk.tx and io_out.clk.rx.

The physical section further includes a many-to-one mapping for the rst1 and rst2 physical signals. Both signals are mapped to the logical signal rs2.reset. The keyword “forall” is used to signify the many-to-one mapping. The physical signals mapped are listed in the parentheses (rst1 and rst2 in this example), and the logical signal to which they are mapped is listed in the braces (rst2.reset in this example).

Finally, the physical section includes a default logical signal mapping, providing a default value for the least significant 12 bits of the logical signal io_out.data. Specifically, binary zeros are used in this case.

Accordingly, the DDF command in FIG. 23 illustrates the one-to-one, many-to-one, and one-to-many mappings described above.

FIG. 24 illustrates the DDF command for chip2, with a single logical port io_in of port type io in the logical section and one-to-one signal mappings in the physical section. Similarly, FIG. 25 illustrates the DDF command for rst_ctl, with a single logical port rst1 of port type rst and one-to-one signal mappings in the physical section.

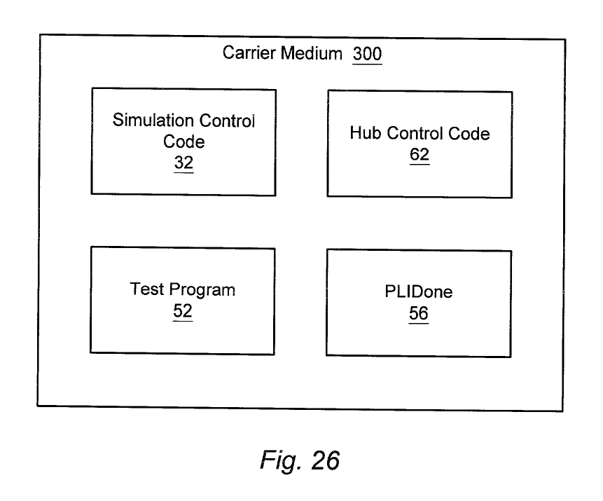

Turning next to FIG. 26, a block diagram of a carrier medium 300 is shown. Generally speaking, a carrier medium may include computer readable media such as storage media (which may include magnetic or optical media, e.g., disk or CD-ROM), volatile or non-volatile memory media such as RAM (e.g. SDRAM, RDRAM, SRAM, etc.), ROM, etc., as well as transmission media or signals such as electrical, electromagnetic, or digital signals, conveyed via a communication medium such as a network and/or a wireless link.

The carrier medium 300 is shown storing the simulation control code 32, the hub control code 62, the test program 52, and the PLIDone model 56. That is, the carrier medium 300 is storing instruction sequences corresponding to the simulation control code 32, the hub control code 62, and the test program 52. Other embodiments may store only one of the simulation control code 32, the hub control code 62, and the test program 52. Still further, other code sequences may be stored (e.g. the simulator 46, the formatter 34, the parser 36, the sockets 38). Additionally, the model 20 and/or the bidi drivers 48 may be stored. The simulation control code 32 may represent embodiments implementing the flowcharts of FIG. 13 or FIGS. 11 and 12. The PLIDone model 56 may represent an embodiment including representations of logic for performing the operations shown in FIGS. 8-10.

The carrier medium 300 as illustrated in FIG. 26 may represent multiple carrier media in multiple computer systems on which the distributed simulation system 10 executes. For example, the simulation control code 32 may be on a carrier medium in a first computer system on which a given DSN executes, and the hub control code 62 may be on a different carrier medium in a second computer system on which the hub executes.

It is noted that, while Verilog and simulator programs designed to the Verilog IEEE specification are used as an example above, other embodiments may use VHDL and simulator programs designed therefore or any other HDL and corresponding simulator programs.

Numerous variations and modifications will become apparent to those skilled in the art once the above disclosure is fully appreciated. It is intended that the following claims be interpreted to embrace all such variations and modifications.

What is claimed is:

1. A distributed simulation system comprising:
a first node configured to simulate a first portion of a system under test using a first simulator program; and
a second node configured to simulate a second portion of a system under test using a second simulator program;
wherein the instruction code comprising the first simulator program differs from the instruction code comprising the second simulator program, and wherein the first node and the second node communicate at least signal values during the simulation using a grammar.

2. The distributed simulation system as recited in claim 1 wherein the first simulator program comprises a first event-based simulator and the second simulator program comprises a second event-based simulator.

3. The distributed simulation system as recited in claim 2 wherein the first event-based simulator includes a first event scheduler which differs from a second event scheduler included in the second event-based simulator.

4. The distributed simulation system as recited in claim 2 wherein the first node further includes a model comprising a representation of logic to perform one or more non-blocking assignments and logic to schedule a call of at least a first code sequence responsive to the non-blocking assignment.

5. The distributed simulation system as recited in claim 1 wherein the first simulator program comprises an event-based simulator and the second simulator program comprises a cycle-based simulator.

6. The distributed simulation system as recited in claim 5 wherein the second node is configured to count a number of timesteps equal to a number of timesteps per clock cycle of the clock corresponding to the cycle-based simulator and to cause the cycle-based simulator to evaluate in response thereto.

7. The distributed simulation system as recited in claim 1 wherein the first node and the second node are configured to communicate via message packets formatted according to a grammar.

8. The distributed simulation system as recited in claim 7 further comprising a hub coupled to the first node and the second node, wherein the hub is configured to route the message packets.

9. The distributed simulation system as recited in claim 7 wherein the grammar includes a first command defining one or more logical ports and one or more logical signals.

10. The distributed simulation system as recited in claim 9 wherein the grammar includes a second command defining a mapping between the logical signals and physical signals of a model of each portion of the system under test.

11. The distributed simulation system as recited in claim 9 wherein the grammar includes a third command defining a routing between the logical ports of the portions of the system under test.

12. A method comprising:
simulating a first portion of a system under test using a first simulator program in a first node of a distributed simulation system; and
simulating a second portion of a system under test using a second simulator program in a second node of the distributed simulation system;
wherein the instruction code comprising the first simulator program differs from the instruction code comprising the second simulator program, and wherein the first node and the second node communicate at least signal values during the simulating using a grammar.

13. The method as recited in claim 12 wherein the first simulator program comprises a first event-based simulator and the second simulator program comprises a second event-based simulator.

14. The method as recited in claim 13 wherein the first event-based simulator includes a first event scheduler which differs from a second event scheduler included in the second event-based simulator.

15. The method as recited in claim 13 further comprising performing one or more non-blocking assignments in the first node; and scheduling a call of at least a first code sequence responsive to performing the non-blocking assignment.

16. The method as recited in claim 12 wherein the first simulator program comprises an event-based simulator and the second simulator program comprises a cycle-based simulator.

17. The method as recited in claim 16 further comprising:
counting a number of timesteps equal to a number of timesteps per clock cycle of the clock corresponding to the cycle-based simulator in the second node; and
causing the cycle-based simulator to evaluate in response to counting the number of timesteps.

18. The method as recited in claim 12 further comprising communicating in the distributed simulation system via message packets formatted according to the grammar.

19. The method as recited in claim 18 further routing the message packets through a hub.

20. The method as recited in claim 19 wherein the grammar includes a first command defining one or more logical ports and one or more logical signals.

21. The method as recited in claim 20 wherein the grammar includes a second command defining a mapping between the logical signals and physical signals of a model of each portion of the system under test.

22. The method as recited in claim 20 wherein the grammar includes a third command defining a routing between the logical ports of the portions of the system under test.

23. A carrier medium comprising:
a first model comprising a representation of logic to perform a non-blocking assignment and logic to schedule a call of at least a first code sequence responsive to the non-blocking assignment, and
the first code sequence comprising instructions executable to sample output signals and drive input signals of a second model.

24. The carrier medium as recited in claim 23 wherein the first code sequence further includes instructions executable to trigger the non-blocking assignment.

25. The carrier medium as recited in claim 24 wherein the first code sequence includes instructions executable to trigger the non-blocking assignment for sampling signals and to trigger the non-blocking assignment again for driving signals.

26. The carrier medium as recited in claim 23 wherein the first model further includes a representation of logic configured to schedule a call of the first code sequence responsive to a sample clock edge.

27. The carrier medium as recited in claim 23 wherein the first model further includes a representation of logic configured to schedule a call of the first code sequence responsive to a timestep transition.

28. A carrier medium comprising instructions executable to:
count timesteps in a distributed simulation system; and
cause a cycle-based simulator to evaluate a clock cycle in a model responsive to a number of the timesteps equaling a number of timesteps per clock cycle of a clock corresponding to the model.

29. The carrier medium as recited in claim 28 further comprising instructions executable to sample output signals of the model and drive input signals of the model.
